(19) United States
(12) Patent Application Publication
(10) Pub. No.: US 2005/0015178 A1
(43) Pub. Date: Jan. 20, 2005

(54) Method and device for applying at least one substance to a yarn

(76) Inventor: Henry Shaw, Steenvoorde (FR)

Correspondence Address: BACON & THOMAS, PLLC, 625 SLATERS LANE, FOURTH FLOOR, ALEXANDRIA, VA, 22314, US

(21) Appl. No.: 10/882,342

(22) Filed: Jul. 2, 2004

(30) Foreign Application Priority Data
Jul. 18, 2003 (EP) 03077274.3

(51) Int. Cl. G06G 7/66

(52) U.S. Cl. 700/139

(57) ABSTRACT

The invention relates to a device for applying at least one substance having a respective characteristic to a yarn moving along a path through a yarn preparation device for manufacturing a fabric. The invention also relates to a yarn preparation device comprising a device for feeding and advancing a yarn from a yarn supply along a yarn moving path and further comprising a yarn treatment device according to the invention. Furthermore the invention also relates a method for applying at least one substance having a respective characteristic to a yarn moving along a path through a yarn preparation device for manufacturing a fabric. According to the invention the device is characterized in that storage means are present storing a pattern representing at least the position-dependent presence of said at least one substance on said yarn and wherein said device is controlled based on said pattern. Thus with the device according to the invention it is possible to preset the device with a specific pattern, based on with the substance is being applied to the yarn.

The invention relates to a device for applying at least one substance having a respective characteristic to a yarn moving along a path through a yarn preparation device for manufacturing a fabric.

The invention also relates to a yarn preparation device comprising a device for feeding and advancing a yarn from a yarn supply along a yarn moving path and further comprising a yarn treatment device according to the invention.

Furthermore the invention also relates to a method for applying at least one substance having a respective characteristic to a yarn moving along a path through a yarn preparation device for manufacturing a fabric.

In this application a substance is referred to an arbitrary substance, which is applied to a yarn, e.g. a sizing agent, dye, ink, glue, varnish, wax, lubricant, elastomer, plastic, hardener, coating, means for preparing the yarn for dyeing, polymers, surface modifying varnishes, surface modifying finishes, agents to be altered at some later stage, microcapsules containing agents to be activated at some later stage or another substance.

Moreover in this application a yarn is referred to an arbitrary element of substantial length, being for example a textile thread, a synthetic or natural fibre or strand, a monofilament or twined monofilaments or a metal wire.

A device and method according to the above introduction are for example known from the International patent application no. PCT/EP01/05993 (WO 01/90461). In WO 01/90461 successive nozzles are positioned in a side-by-side manner along the moving path of the yarn. Via said nozzles substances in the form of droplets are ejected towards the yarn. The substance is applied in pulses, of which the pulse frequency and/or pulse amplitude is controlled in accordance with the speed and/or tension of the yarn moving along its moving path.

Thus in WO 01/90461 the quality of the coverage of the yarn with said substances is improved, although it is only possible to control the coverage of a predetermined amount of substance per length-unit of the yarn being processed.

It is an object of the present invention to provide a device as stated above having improved capabilities in applying a substance to a yarn, thus significantly improving its speed and versatility.

According to the invention the device is characterized in that storage means are present storing a pattern representing at least the position-dependent presence of said at least one substance on said yarn and wherein said device is controlled based on said pattern.

Thus with the device according to the invention it is possible to preset the device with a specific pattern, based on which the substance is being applied to the yarn.

In a further improvement the device comprises detection means for monitoring the pattern of said at least one substance being applied to said yarn and for controlling said device based on a comparison between said pattern contained in said storage means and said monitored pattern.

This allows a sophisticated and direct control of the result thus generated and more in particular said comparison is partly based on detecting specific marks present in said pattern with said detection means, for example reference marks applied to said yarn.

The reference marks can be applied to the yarn using a specific substance intended for marking or tagging purposes. For example said tagging substance can be invisible for the human eye, but can become visible when irradiated with a specific light source being part of the detection means. Also other “invisible” tagging substance becoming “visible” when undergoing a specific treatment (irradiated by light, subjected to heat, etc.) are possible.

More in particular said device is arranged for repositioning the yarn relative to the fabric being manufactured based on said comparison. This allows a direct correction of the process during operation, as a possible manufacturing error can be noticed in advance during the process of manufacturing. The manufacturing errors are no longer noticed long after the fabric has been manufactured, thereby significantly reducing waste and rejected products.

More in particular said repositioning of the yarn is performed as the device according to the invention further comprises means for repositioning said yarn a certain distance back or forth along said path of movement.

In a specific constructional embodiment of the repositioning means a gripping element for gripping a free end of said yarn is provided.

In the event a manufacturing error or an irregularity has occurred the device according to the invention is capable of repositioning the yarn relative to the fabric being manufactured as stated above.

However in some situations repositioning of a single yarn may be insufficient to correct an error in the process. To this end said storage means are arranged for altering the pattern stored relative to said fabric in event of the occurrence of an irregularity in the yarn preparation process.

In one embodiment said storage means are arranged for shifting said pattern stored relative to the fabric being manufactured, wherein in another embodiment said storage means are arranged for altering said pattern stored by rearranging and restoring said pattern.

More in particular said storage means are arranged for rearranging said pattern stored, thereby obtaining an optimal coverage of the, fabric being manufactured. This means that the storage means are overruling the current yarn preparation process being performed by the device and the device is controlled in such manner that the yarn preparation process “restarts” now with another, rearranged and more optimal pattern to be applied as to the coverage of the fabric being manufactured. Thus with this feature waste material is significantly reduced.

The method according to the invention is further characterized by the steps of storing a pattern representing at least the position-dependent presence of said at least one substance on said fabric and controlling the application of said substance based on said pattern.

The invention shall now be described by means of the enclosed description, in which drawing shows:

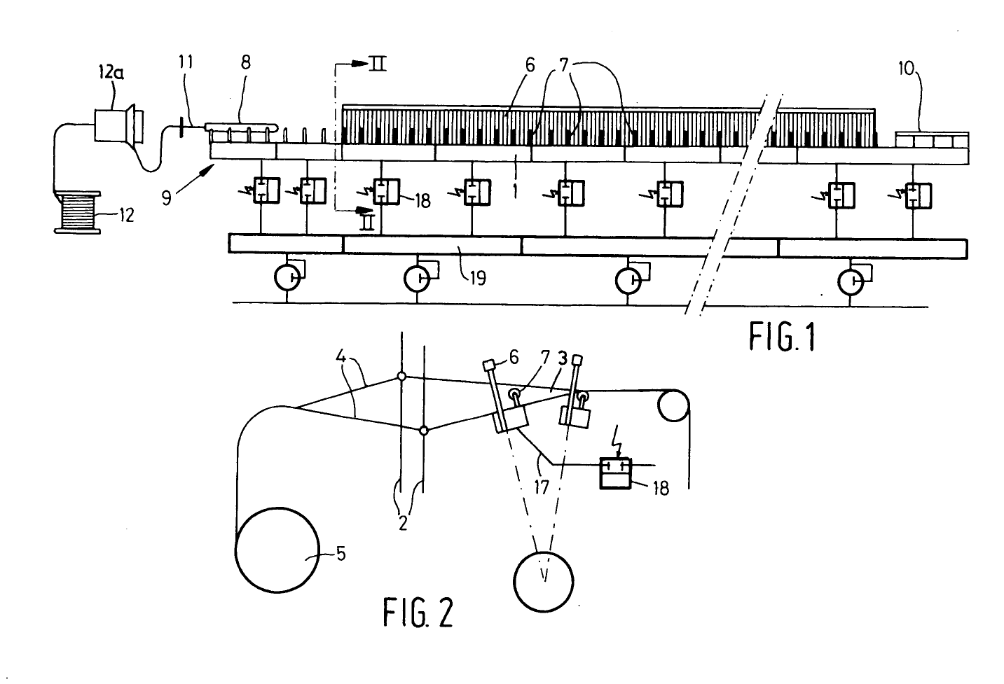

FIGS. 1-2 a yarn preparation device according to the state of the art, wherein the device according to the invention can be implemented;

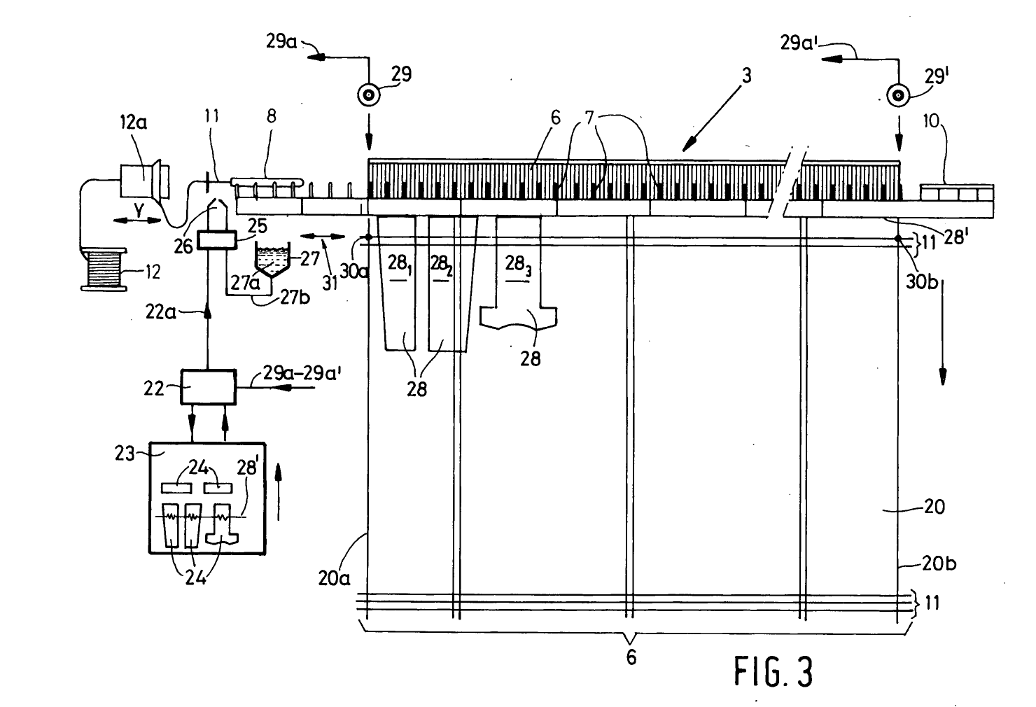

FIG. 3 a first embodiment of a device according to the invention;

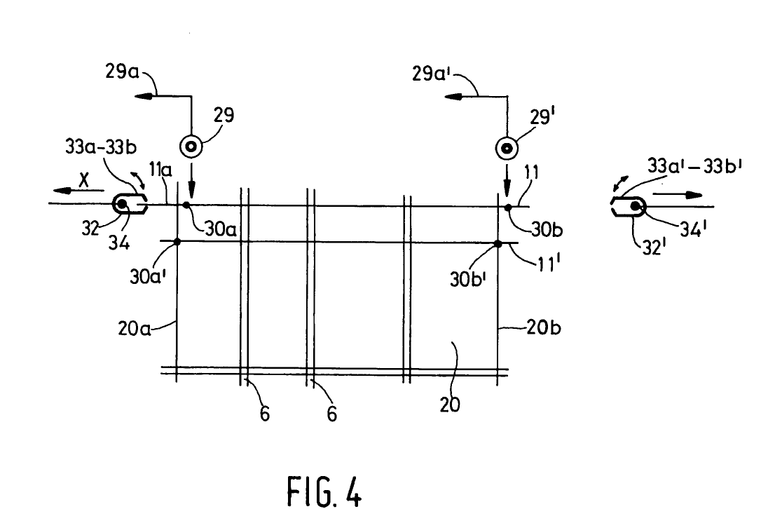

FIG. 4 a detailed view of the embodiment of FIG. 3

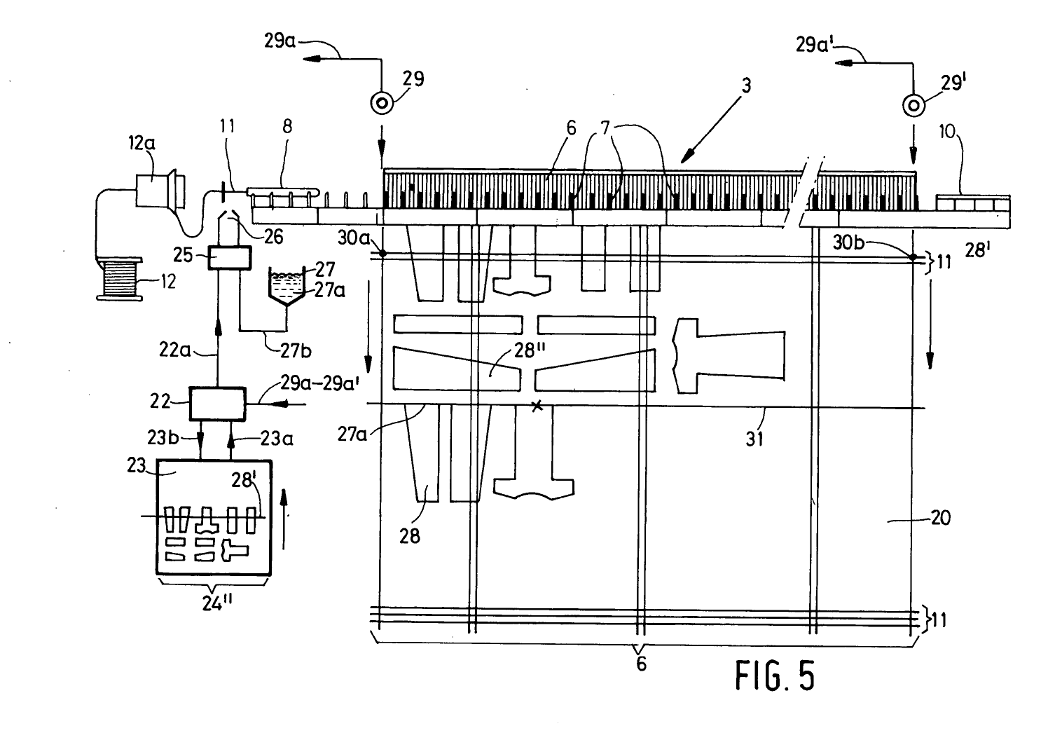

FIG. 5 a second embodiment of a device according to the invention.

FIGS. 1 and 2 schematically shows a known yarn preparation device and more in particular a weaving device, which yarn preparation device can be used with the device according to the invention.

It is to be noted that the following detailed description of the device according to the invention is solely for illustrative purposes and the invention shall not be considered limited to a yarn preparation device according to FIGS. 1 and 2. Also yarn preparation devices other than weaving devices, wherein a single yarn is processed along a moving path, are highly suitable to be implemented with the device according to the invention.

The yarn preparation device comprises a sley 1 and means 2 for forming a shed 3 of warp threads 4, which threads 4 come from supply spools for the warp threads 5. A large number of reed dents 6 are provided on sley 1, said weft means together forming the so-called reed and being capable of movement between warp threads 4. Furthermore a number of guides 7 are provided on sley 1 for guiding a projectile 8 through shed 3 from one side to the other. As is shown in FIG. 1, the projectile 8 is present in the introducing station 9 positioned on the left-hand side of the shed, whilst a decelerating station 10 is present on the other side of the shed.

A weft thread or yarn 11 from a supply spool 12 is stored in one or more windings on a yarn feeding device 12a and may be connected to the projectile 8 in a known manner. Subsequently the projectile 8 is accelerated in the introducing station 9, in this embodiment by imparting impulse energy to the projectile 8 using a pressurized medium, like pressurized air or water and displaced through the shed 3 inserting the yarn 11 through the shed 3.

At the right-side of the shed 3 a deceleration station 10 is disposed for receiving and decelerating the projectile 8 with the yarn 11. Then the projectile 8 can be returned to the introducing station 9 for a subsequent “sweep” through the shed 3, or the projectile 8 can be accelerated again by an introducing station 9′ (not shown) present near the deceleration station 10. In that embodiment a further deceleration station 10′ (not shown) is disposed near the introducing station 9.

Like the yarn preparation device as disclosed in WO 01/90461 a fabric of subsequent inserted weft yarns 11 woven between warp threads 4 is created. FIG. 3 discloses a first embodiment of a device according to the invention implemented in a yarn preparation device as for example disclosed in FIGS. 1 and 2.

As described in the International patent application WO 01/90461 the device consists of a nozzle 26 connected to a driving unit 25. The nozzle 26 is furthermore connected via supply line 27b to a supply 27 containing a specific type of substance 27a.

With the driving means 25 it is possible to draw substance 27a contained in reservoir 27 to supply line 27b towards the nozzle 26 where the substance 27a is ejected as a jet or a sequence of droplets towards the weft yarn 11. With this device it is possible to apply said substance to the weft yarn 11 upon insertion through the shed 3 formed of warp threads 6 (see also FIG. 2).

According to the invention the device comprises storage means 22 connected via a connection line 22a to the driving device 25 of nozzle 26. In said storage means 22 a suitable storage element, like a EPROM or other memory means indicated with reference numeral 23 is present in which storage element or memory means 23 a pattern 24 is stored representing a pattern of said substance 27a to be applied to the yarn 11 in order to obtain a fabric 20 having a pattern lay-out 28 identical to the pattern stored in the storage element 23.

Said pattern 24 in storage element 23 consists of data electronically stored representing the position-dependent presence of said substance 27a on said yarn 11.

In this embodiment the pattern 24 contained in storage element 23 of storage means 22 consists of specific parts of a specific kind of clothes for example a trouser (parts 28₁, and 28₂) or a blouse (part 28₃). The substance 27a applied in said pattern 28 on fabric 20 can be a dye of a specific colour or it can be a substance having another characteristic for example a substance withstanding transpiration. The substance 27a being applied to said weft yarn 11 can for example also have a specific reinforcement characteristic in order to reduce wear of said parts of said fabric 20 when used to manufacture clothes.

During operation said storage means 22 read said pattern-data in a line-by-line manner, wherein each line represents the position-dependent presence of said substance 27a for one weft yarn 11 to be inserted through shed 3 of the yarn preparation device. Hence the storage means 22 is controlling the driving device 25 based on said data-pattern on line-by-line basis, such that each data-line relates to a single yarn 11.

For example, the position-dependent presence of the substance 27a as represented by data-line 28′ in storage element 23 will control the driving device 25 of the nozzle 26 in such manner that the weft yarn 11 inserted through shed 3 at that time obtains a coverage of the substance 27a being conformal to the data-line 28′ in storage element 23. In FIG. 3 the weft yarn 11 thus processed by nozzle 26 exhibits a substance coverage as depicted with reference numeral 28′ in shed 3.

With this embodiment according to the invention the storage means 22 are arranged for reading said data-pattern stored in storage element 23 on a line-by-line manner thereby controlling the driving device 25 of the nozzle 26 such that said data-pattern 24 contained in storage element 23 eventually will result in a substance-pattern 28 in fabric 20.

According to a further aspect of the device according to the invention also detection means 29 are provided for monitoring the pattern 28 of said substance 27a being applied to said yarns 11 forming a fabric 20 which detection means 29 are connected to said storage means 22 via connection line 29a.

Said detection means can be arranged as a vision camera performing continuous visual monitoring of each yarn 11 inserted through shed 3, which yarns 11 are provided with a substance-coverage conformal to a corresponding data-pattern line 28′ contained in said storage element 23. Moreover said visual information representing the actual substance-coverage on the yarn 11 (and thus the fabric 20) as provided by said detection means 29 is transferred via connection line 29a towards the storage means 22, which means 22 compare said substance-coverage of said yarn 11 with the corresponding data-pattern line contained in said storage element 23.

Based on said comparison the device according to the invention is arranged for repositioning a specific yarn 11 relative to the fabric 20 to be manufactured in the event that the substance-coverage on said yarn does not conform the corresponding data-pattern line 28′ contained in said storage element 23. Said comparison can use specific marks, indicated with reference numerals 30a and 30b, present in said pattern which are in this embodiment specific reference marks of said substance 27a applied to said yarn.

FIG. 3 clearly shows two reference marks 30a-30b present on the yarn 11, which reference marks are located on either outer edges of said fabric 20. In the event that the reference marks 30a-30b are shifted relative to the outer edges of said fabric 20 for example due to the fact that the weft yarn 11 on which said reference marks 30a-30b are applied is positioned incorrectly within the shed 3 it is necessary to reposition the yarn relative to the fabric 20 in order to maintain the same, correct pattern 28 on said fabric and to avoid yarn processing (weaving) errors, which may lead to a disapproval of the fabric 20 thus manufactured resulting in waste material.

An embodiment of said repositioning means is disclosed in FIG. 4 comprising gripping element 32-32′ positioned at either side of the shed 3/fabric 20. Each gripping element 32-32′ consist of two clamping members 33a-33b and 33a′-33b′ respectively which clamping members can be moved towards and from each other using a suitable driving mechanism 34-34′. In FIG. 4 a weft yarn 11′ is shown having two reference marks 30a′ and 30b′ serving as specific marks consisting of a specific amount of substance applied to said yarn with said nozzle 26. Said specific substance can be invisible to the human eye which invisible substance only becomes visible when a specific preparation step is performed. This specific preparation step can for example be irradiation with light or by applying heat to the fabric 20 in order to trace the actual position of the reference marks 30a′-30b′.

The reference marks 30a′-30b′ of yarn 11′ are correctly aligned with the outer edges 20a-20b of said fabric 20. However the cut-off free end of yarn 11 is incorrectly positioned with respect to said fabric 20 as its reference marks 30a-30b are not in line with the outer edges 20a-20b. This shift in position of the yarn 11 relative to the fabric 20 is monitored by said detection means 29 and 29′ respectively as the comparison between the substance-coverage on said yarn 11 does not conform the corresponding data-pattern line contained in said storage element 23 of said storage means 22.

In such event the repositioning means 32 are activated fixating the yarn 11 between the clamping members 33a-33b. Subsequently the said gripping member 32 is displaced in the direction of arrow X which displacement is monitored by said detection means 29-29′ until the reference marks 30a-30b are aligned with the outer edges 20a-20b of said fabric 20. Likewise gripping element 32′ can be used for further advancing the yarn 11 in the event that reference mark 30b still lies between the outer edges 20a-20b of said fabric. With gripping element 32′ the yarn 11 is further advanced, said advancement also being monitored by detection means 29′ until reference mark 30b aligns with the outer edge 20b of fabric 20.

Another implementation of the invention does not involve the use of gripping elements 32-32′. As described with reference to FIG. 2 the projectile 8 inserts each yarn 11 through the shed 3 whilst the substance 27 is being applied by nozzle 26 according to a specific data-line pattern contained in storage element 23. Each yarn 11 is also provided with reference marks 30a and 30b. The projectile 8 can be provided with a clamping mechanism for clamping the yarn upon insertion through the shed 3, which mechanism can be deactivated by a suitable control signal at the time the detection means 29-29′ detect the correct positioning of the reference marks 30a-30b with reference to the outer dimensions 20a-20b of fabric 20, thereby releasing the yarn 11.

This clamping mechanism can be construed as electro-magnetic solenoid switches, which are light and exhibit a fast response time.

In yet another embodiment of the repositioning means it is also possible to displace the yarn feeding device 12a (see arrow Y in FIG. 3) during the insertion step of the yarn 11 being drawn-off from said yarn feeding device towards shed 3 in order to correct the difference in the location of the reference marks 30a-30b on the yarn 11 with respect to the outer edges of the fabric 20.

It is also possible to reposition the nozzle 26 relative to the yarn being processed in a direction parallel to the moving path of yarn 11.

In FIG. 5 another embodiment of the device according to the invention is disclosed wherein the storage means 20 are arranged for rearranging the pattern 24 as stored in storage element 23 in the event of an occurrence of an irregularity in the yarn preparation process, for example a malfunction.

In FIG. 5 an example of an irregularity is disclosed wherein the weft yarn 31 has broken during insertion through the shed 3. The point where the yarn 31 has broken is depicted in FIG. 5 with the cross on line 31. This means that the pattern 28 being applied to the yarns 11 of fabric 20 has been interrupted making the fabric containing said pattern of substance useless for further processing. When the yarn preparation device has to be interrupted the control of the yarn preparation device by said storage means 22 has to be reset. Furthermore the whole process of applying said substance-pattern 28 to said fabric 20 has to be repeated by rereading said data-pattern 24 in a line-by-line manner.

However this may lead to an infective coverage of the fabric 20 with said substance forming pattern 28 resulting in unnecessary and undesired waste material, which can not be used for the further processing steps of the fabric 20 (for example the manufacturing of clothes).

At the time an irregularity is detected, for example by the detection means 29 the storage means 22 may interrupt the driving device 25 interrupting the application of said data-pattern 24 (see FIG. 3) in a line-by-line manner to the weft yarn 11.

Based on the information provided by sensing means 29 said storage means 22 recalculates the data-pattern contained in said storage element 23 in such manner that the most effective and efficient coverage of said fabric 20 is obtained at the time the yarn processing step is continued.

More in particular visual information concerning an irregularity in the fabric 20 being manufactured is observed by said detection means 29 and transferred via signal line 29a towards said storage means 22, which means 22 uses said image information of the irregularity in fabric 20 (the broken weft yarn 31) to reprogram via signal line 23b storage element 23 resulting in a new pattern 24″ having another layout.

This is clearly shown in FIG. 5, wherein the former pattern 28 partly present on said fabric 20 is interrupted and replaced by a new pattern 28″ consisting of the same pattern elements with the same dimensions. Now reorientated (reprogrammed) with respect to said fabric 20 in order to obtain the most effective coverage, said new data-pattern 24″ is processed in a line-by-line manner by said storage means 22. Similar to the embodiment as shown in FIG. 3 the storage means 22 reads said data-pattern stored in said storage element 23 in a line-by-line manner which data is transferred via signal line 23a and signal line 22a towards driving device 25 of the nozzle 26.

Said rearranged pattern 24″ is again read line-by-line (for example data line 28′) which data is used to drive the nozzle 26 in such manner that the rearranged pattern 24″ is applied to subsequent weft yarns 11 in order to obtain a substance-pattern 28″ on fabric 20.

In another correction technique the pattern 24 as originally stored is not rearranged into a new pattern 24″ having another layout. Instead the pattern 24 is shifted with respect to the fabric being manufactured, thereby also shifting the pattern 28 being applied to said fabric 20. With this shifting technique yarns 11 incorrectly positioned with respect to the outer dimensions 20a-20b of the fabric 20 are accepted and not repositioned or removed using the gripping elements 32-32′ of FIG. 4.

Instead the shift of the reference marks 30a-30b relative to the outer dimensions 20a-20b of fabric 20 are measured using the detection means 29-29′ and said shift is used to shift the pattern 24 in storage elements. Subsequent yarns 11 are now correctly treated by nozzle 26 as the corresponding data-pattern line 28′ in pattern 24 is shifted relative to its original orientation with respect to said yarn 11.

In the event the reference mark 30a (and 30b) of a yarn 28′ in shed 3 (see FIG. 3) is shifted 2 mm to the left relative to the outer dimension 20a of fabric 20, subsequent data-pattern lines contained in storage element 23 are applied later in time to subsequent yarns 11 such that the pattern present on said subsequent yarns are in alignment with the pattern present on the previous shifted yarn 11. Also when a yarn is shifted to the right, subsequent data-pattern lines are applied earlier in time. In both situations the pattern applied on said subsequent yarns is shifted relative to the reference marks 30a-30b on said yarn.

With this correction technique an incorrect position of one or more yarns relative to the fabric 20 are accepted and the position or shift error is used for correcting the process of applying the substance to subsequent yarns. Only in the event that the shift error is too great said yarn 11 is removed from the shed 3 using the gripping means 32-32′ and a new yarn 11 now correctly provided with substance according to the corresponding data-pattern line present in storage element 23 is inserted through the shed 3.

Instead of altering (that is rearranging or shifting) the original layout of the pattern 24 stored in storage element 23 it is according to the invention also possible to remove the faulty yarn or yarns 31 (FIG. 5) from the fabric 20, for example by using the gripping element 32-32′ of FIG. 4. The yarn or yarns 31 provided with an incorrect coverage of the substance 27 (or broken yarns 31) are pulled out of the fabric 20. Subsequently the process of applying the substance 27 according to the pattern 24 stored in storage element 23 is restarted, wherein the data-pattern line or lines 28′ (see FIG. 3) corresponding with the faulty yarns 31 being removed from the fabric 20 are read again by the storage means 22 for controlling driving means 25 of nozzle 26. With this correction technique the pattern 24 as originally stored is not altered or rearranged.

It should be noted the invention is not limited to the use of a projectile 8 as described above, but that also other means like a gripper mounted a rapier or an air-jet, water-jet or any other kind of weft insertion means can be used to move or displace a yarn along a path of movement.

It should also be noted that more than one substance can be applied to the yarn 11 using several nozzle-arrangements, each intended for one substance. Each nozzle-arrangement thus comprises a nozzle 26 combined with driving means 25 and a supply 27 for containing said specific substance 27a and being connected to the nozzle 26 via a supply line 27b. Also each nozzle 26 can be controlled by corresponding storage means 22 with a storage element 23 in which a pattern 24 is stored representing the position-dependent presence of said specific substance on said yarn 11.

It is also possible to implement one storage means 22 with one pattern containing the position-dependent data for all substances being applied by several nozzle-arrangements described above, which single storage means 22 is used to control all several nozzles 26.

An aspect of the invention has to be seen in the time-dependent applying the substance to a yarn, for example dependent on the velocity of the yarn 11 during insertion in the shed 3. The yarns are being inserted with a velocity which may differ from each other. When applying the substance to the yarns it is necessary of taking these velocity-differences into account. To this end velocity-sensors can be positioned near the yarn insertion station 9. Based on the velocity of the yarn a time-dependent application of the substance to said yarn is required. This means that the position-dependent presence of the substance (stored as a data-pattern line in storage element 23) is applied in a specific time interval to the yarn, which time interval is directly related to the velocity of said yarn. A fast moving yarn requires a small time interval, whilst a slowly moving yarn requires a longer time interval, during which time intervals the substance is applied.

This avoids a substance being applied to the yarn over a longer (or shorter) length than required according to the pattern stored in the storage element 23 in the event the yarn is moving faster (or slower) than supposed. In fact the substance is spread out over the yarn or thickened on said yarn. These irregularities can be avoided, when the time interval during which the corresponding data-pattern line has to be applied to the yarn by the nozzle 26 is altered.

With another implementation of the invention each yarn is treated with the same time interval. In other words the storage means 22 read each data-pattern line 28′ from the storage element 23 with the same reading time. However in order to correct an occurred position shift of a yarn with respect to the fabric 20 the storage means are arranged to widen or to narrow the corresponding data-pattern line 28′ stored in storage element 23. This means that in the storage element 23 the position-dependent presence of the substance 27 on said yarn 11 is repositioned with respect to said yarn. The storage means can widen or narrow said data-pattern line as a whole or only parts of said data-pattern line, for example only the middle part of the data-pattern line, whereas the beginning and the end of the position-dependent presence of the substance remains unaltered/unchanged.

With this feature it is also possible to correct for a yarn being elastic in length and which yarn is lengthened or stretched during insertion through the shed 3 and returns to its initial length after insertion.

A more sophisticated control of the device is obtained when the time interval, during which interval a data-pattern line 28′ is read and used to control the nozzle 26 for applying at least one substance according to the corresponding pattern on a yarn is controlled, such that the reference marks 30a-30b will be positioned relative to at least the outer dimensions 20a-20b of the fabric. This ensures a proper orientation of each yarn relative to the fabric 20 being manufactured and ensures that the pattern 28 being applied matches or nearly matches the pattern 24 stored in storage element 23.

This control is based on monitoring the pattern 28′ of said at least one substance applied to a yarn 11 with the detection means 29-29′ and comparing this pattern with the stored pattern 24 and the time interval during which a data-pattern line 28′ in the storage element is read and processed for applying at least one substance is controlled such that both patterns 28 and 24 correspond.

Of course more reference marks than reference marks 30a-30b applied to each yarn can be used in order to improve the accuracy of the control of the nozzle 26 and the data-pattern lines stored in storage element 23 could be processed with a speed such that each reference mark corresponds with a predetermined position of the weft along the fabric 20. To this end several detectors being part of detection means 29-29′ should be arranged at several predetermined positions along the shed 3. A correct processing of each data-pattern line 28′ in storage element 23 by the storage means is obtained when the several reference marks (e.g. ten marks) are in alignment with their corresponding detector.

1. Device for applying at least one substance (27) having a respective characteristic to a yarn (11) moving along a path through a yarn preparation device for manufacturing a fabric (20), characterized in that storage means (22) are present storing a pattern (24, 24″) representing at least the position-dependent presence (28, 28″) of said at least one substance on said yarn and wherein said device is controlled based on said pattern.

2. Device according to claim 1, characterized in that said device further comprises detection means (29, 29′) for monitoring the pattern (28, 28″) of said at least one substance being applied to said yarn (11) and for controlling said device based on a comparison between said pattern (24, 24″) contained in said storage means and said monitored pattern (28, 28″).

3. Device according to claim 2, characterized in that said detection means (29, 29′) are arranged for detecting specific marks (30a, 30b) present in said pattern (28, 28″), for example reference marks applied to said yarn (11).

4. Device according to claim 2, characterized in that based on said comparison said device is arranged for repositioning the yarn (11) relative to the fabric (20) being manufactured.

5. Device according to claim 4, characterized in that the device further comprising means (32, 32′) for repositioning said yarn a certain distance back or forth along said path of movement.

6. Device according to claim 5, characterized in that the repositioning means (32, 32′) comprise a gripping element (33a-33b, 33a′-33b′) for gripping a free end of said yarn (11).

7. Device according to claim 1, characterized in that said storage means (22) are arranged for altering the pattern stored (24) relative to said fabric (20) in event of the occurrence of an irregularity in the yarn preparation process.

8. Device according to claim 7, characterized in that said storage means (22) are arranged for shifting said pattern (24) stored relative to the fabric (20) being manufactured.

9. Device according to claim 7, characterized in that said storage means (22) are arranged for altering said pattern (24) stored by rearranging and restoring said pattern (24″).

10. Device according to claim 9, characterized in that said storage means (22) are arranged for rearranging said pattern stored obtaining an optimal coverage of the fabric (20) being manufactured.

11. Yarn preparation device comprising means (12a, 9) for feeding and advancing a yarn (11) from a yarn supply (12) along a yarn moving path and further comprising a yarn treatment device according to any one of the preceding claims.

12. Method for applying at least one substance having a respective characteristic to a yarn moving along a path through a yarn preparation device for manufacturing a fabric, further characterized by the steps of storing a pattern representing at least the position-dependent presence of said at least one substance on said fabric and controlling the application of said substance based on said pattern.

13. Method according to claim 12, characterized by the further steps of monitoring the pattern of said at least one substance being applied to said yarn, comparing said pattern being monitored with said pattern being stored, and controlling the application of said substance based on said comparison.

14. Method according to claim 13, characterized by the further step of repositioning the yarn relative to the fabric being manufactured based on said comparison.

15. Method according to claim 12, characterized by the further step of altering the pattern being stored relative to said fabric in event of the occurrence of an irregularity in the yarn preparation process.

16. Method according to claim 12, characterized by the further step of altering said pattern being stored for obtaining an optimal coverage of the fabric being manufactured.
